(19) United States
(12) Patent Application Publication
(10) Pub. No.: US 2010/0006319 A1
(43) Pub. Date: Jan. 14, 2010

(54) CABLE STRUCTURE

(75) Inventor: Te-Li HUANG, Jhonghe City (TW)

Correspondence Address: YOUNG & THOMPSON, 209 Madison Street, Suite 500, Alexandria, VA, 22314, US

(73) Assignee: COPARTNER TECHNOLOGY CORP, JHONGHE CITY (TW)

(21) Appl. No.: 12/499,257

(22) Filed: Jul. 8, 2009

(30) Foreign Application Priority Data
Jul. 8, 2008 (TW) 097212106

(51) Int. Cl. H01B 9/02; H01B 7/08

(52) U.S. Cl. 174/107; 174/117 R

(57) ABSTRACT

The present invention provides an improved cable structure, which comprising: a first conductor; a second conductor at one side of the first conductor; a coating unit covered externally onto the first and second conductors, so that the central distance of the first and second conductors is a stable distance; moreover, one surface of the coating unit is provided with a plane portion, and the other surface provided with a depressed portion between the first and second conductors. Thus, the cable could be used to balance efficiently the impedance and realize zero delay difference during HF signal transmission.

### BACKGROUND OF INVENTION

1. Field of the Invention

The present invention relates generally to a cable structure, and more particularly to an innovative one which is used to balance efficiently the impedance and realize zero delay difference during HF signal transmission.

2. Description of Related Art

When a common cable is used for HF audio/video signal transmission (e.g. FIGS. 4˜5), two cores 6, 7 are placed in parallel and then twisted for HF audio/video signal transmission.

Despite of this application, the central distance d of the conductors 61, 71 may deviate due to the degree of tightness and stability of the twisted cores 6, 7. While it is difficult to maintain the central distance d, the impedance will increase or drop, leading to unstable or varied delay difference of HF audio/video signal transmission time and poorer transmission property.

### SUMMARY OF THE INVENTION

For this reason, the major purpose of the present invention is to, based on the stable central distance of first and second conductors, balance efficiently the impedance and realize zero delay difference during HF signal transmission.

The present invention provides an improved cable structure, which comprising: a first conductor; a second conductor at one side of the first conductor; and a coating unit covered externally onto the first and second conductors, so that the central distance of the first and second conductors is a stable distance; moreover, one surface of the coating unit is provided with a plane portion, and the other surface provided with a depressed portion between the first and second conductors.

### DETAILED DESCRIPTION OF THE INVENTION

Referring to FIGS. 1˜2—three-dimensional outside view and cross-sectional view of the present invention, wherein the improved cable structure of the present invention comprises at least a first conductor 1, a second conductor 2 and a coating unit 3. Said second conductor 2 is arranged closely to one side of the first conductor 1. The coating unit 3 is covered externally onto the first and second conductors 1, 2, so that the central distance D of the first and second conductors 1, 2 is a stable distance; moreover, one surface of the coating unit 3 is provided with a plane portion 31, and the other surface provided with a depressed portion 32 between the first and second conductors 1, 2; a curved portion 33 is separately arranged at each side of the coating unit 3.

Referring to FIG. 3—an operating view of the present invention, wherein a grounding wire 4 is arranged in the depressed portion 32 of the coating unit 3; a shielding layer 5 is covered externally onto the coating unit 3 and grounding wire 4; and an insulating layer 6 is covered externally onto the shielding layer 5, of which the shielding layer 5 is an aluminum mylar drain wire that electrically contacts with the grounding wire 4; when the cable of the present invention is used for HF audio/video signal transmission, since the central distance of the first and second conductors 1, 2 is kept stable, and there is an equal distance between the first and second conductors 1, 2, the cable structure could be used for HF signal transmission with zero delay difference.

Based on the aforementioned improved structure, the cable could be used to balance efficiently the impedance and realize zero delay difference during HF signal transmission, so the present invention is claimed hereto since it can meet the customer demands with improved applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE DRAWINGS

FIG. 1 depicts a perspective external view of the present invention.

FIG. 2 depicts a cross-sectional view of the present invention.

FIG. 3 depicts an operating view of the present invention.

FIG. 4 depicts a typical cross-sectional view.

FIG. 5 depicts a typical twisting view.

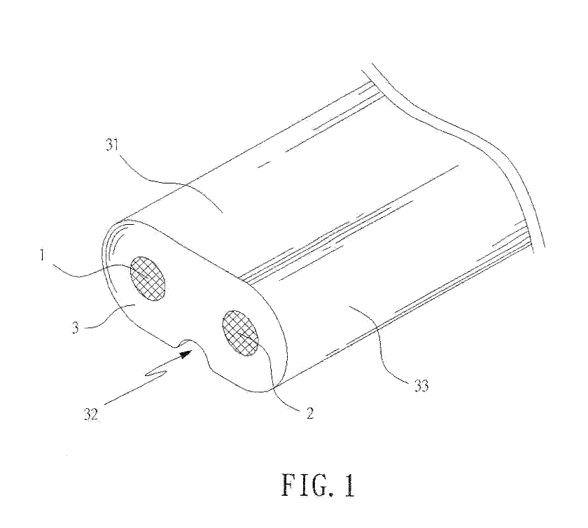

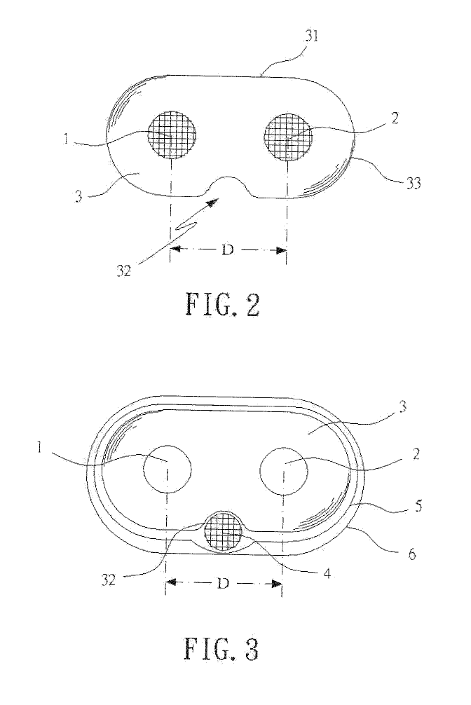

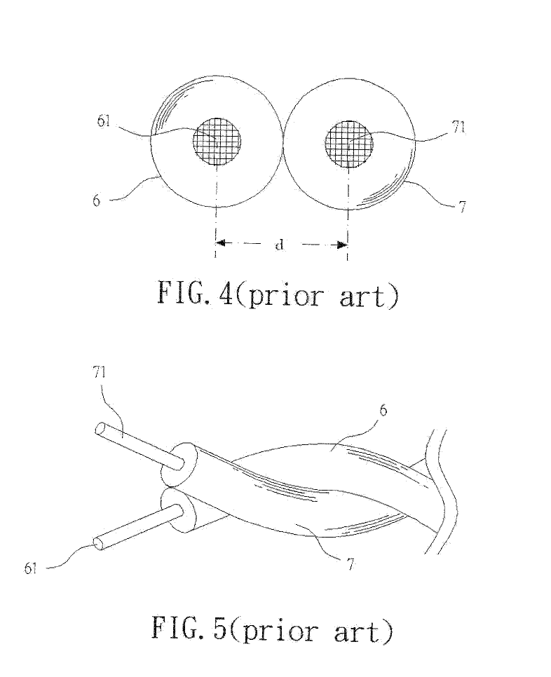

1. An improved cable structure, comprising:
a first conductor;
a second conductor, arranged at one side of the first conductor; and;
a coating unit, covered externally onto the first and second conductors, so that the central distance of the first and second conductors is a stable distance; moreover, one surface of the coating unit is provided with a plane portion, and the other surface provided with a depressed portion between the first and second conductors.

2. The improved structure defined in claim 1, wherein a curved portion is separately arranged at each side of the coating unit.

3. The improved structure defined in claim 1, wherein a grounding wire is arranged in the depressed portion of the coating unit; a shielding layer is covered externally onto the coating unit and grounding wire; and an insulating layer is covered externally onto the shielding layer.

4. The improved structure defined in claim 3, wherein said shielding layer is an aluminum mylar drain wire that electrically contacts with the grounding wire.
